(19) United States
(12) Patent Application Publication
(10) Pub. No.: US 2012/0237744 A1
(43) Pub. Date: Sep. 20, 2012

(54) GLASS-COATED FLEXIBLE POLYMERIC SUBSTRATES IN PHOTOVOLTAIC CELLS

(75) Inventors: Salah Boussaad, Wilmington, DE (US); Damien Francis Reardon, Wilmington, DE (US)

(73) Assignee: E. I. DU PONT DE NEMOURS AND COMPANY, Wilmington, DE (US)

(21) Appl. No.: 13/232,243

(22) Filed: Sep. 14, 2011

Related U.S. Application Data
(60) Provisional application No. 61/382,506, filed on Sep. 14, 2010.
(60) Provisional application No. 61/382,512, filed on Sep. 14, 2010.

(51) Int. Cl. B32B 17/10; B05D 3/02; B32B 27/20; B32B 27/36; B32B 27/34

(52) U.S. Cl. 428/215; 428/426; 428/430; 428/435; 428/428; 428/427; 427/126.4

(57) ABSTRACT

The present disclosure relates to a method of manufacturing of a glass coated flexible polymeric substrate. This invention also relates to a coated flexible polymeric substrate that is suitable for manufacturing flexible solar cells and electronic devices.

### FIELD OF THE INVENTION

The present disclosure relates to a method of manufacturing a glass-coated flexible substrate product. This invention also relates to a coated substrate material that is suitable for manufacturing flexible solar cells and other articles.

### BACKGROUND

Photovoltaic cells are made by depositing various layers of materials on a substrate. The substrate can be rigid (e.g., glass or a silicon wafer) or flexible (e.g., a metal or polymer sheet).

The most common substrate material used in the manufacture of thin-film Cu(In,Ga)Se₂ (CIGS) solar cells is soda lime glass. Soda lime glass contributes to the efficiency of the solar cell, due to the diffusion of an alkali metal (primarily sodium) from the glass into the CIGS layer. However, batch production of CIGS on glass substrates is expensive and glass is typically too rigid to be adapted to a roll-to-roll process. The disadvantages of using common glass substrates for the photovoltaic cells have motivated the search for substrates that are flexible, tolerant of the high temperatures used to create the photoactive layers, inexpensive and suitable for use in roll-to-roll processes.

Several materials have been tested as substrate materials for flexible CIGS solar cells, including polymers such as polyimide and metals such as molybdenum, aluminum and titanium foils. The substrate should be tolerant of temperatures up to 800° C. and reducing atmospheres. A metallic substrate must also be electrically insulated from the back contact to facilitate production of CIGS modules with integrated series connections. It is desirable for the coefficient of thermal expansion (CTE) of the substrate material to be as close as possible to the CTE of the electrical insulating material to avoid thermal cracking or delamination of the insulating material from the substrate.

There is also interest in developing CZTS-Se based solar cells, analogous to CIGS solar cells except that CIGS is replaced by CZTS-Se, where “CZTS-Se” encompass all possible combinations of Cu₂ZnSn(S,Se)₄, including Cu₂ZnSnS₄, Cu₂ZnSnSe₄, and Cu₂ZnSnSₓSe₄₋ₓ, where 0≦x≦4.

Since polymers are generally not thermally stable above 450° C., coated metal substrates have been desirable since temperatures of above 450° C. are routinely achieved in many applications, including photovoltaic cells.

To form an electrically insulating layer on the metal substrate, it is known to deposit SiOₓ or SiO₂ onto metal strips in batch-type deposition processes.

It is also known to coat a metallic base with a first coat of an alkali silicate, optionally containing alumina particles. A second coat of silicone can be applied onto the first coat of an alkali silicate.

In another approach, a stainless steel plate is contacted with a solution of a metal alkoxide, an organoalkoxysilane, water, and thickeners such as alkoxy silane in an organic solvent, then dried and calcined.

A method for producing a substrate for solar batteries has also been disclosed in which a first insulating layer is formed on a metal plate (e.g., a stainless steel plate). Then the surface of the metal plate exposed by pinholes in the first insulating layer is oxidized by heating the metal plate in air. A second insulating layer is then applied over the first insulating layer.

A coated steel substrate useful as a substrate for flexible CIGS solar cells has been disclosed that comprises a stainless steel strip coated with a sodium-doped alumina layer onto which an electrically conducting layer of molybdenum has been deposited.

A process for forming an electrically insulating layer of aluminum oxide on ferritic stainless steel has been disclosed. The alumina-coated stainless steel sheet was used as a substrate for an amorphous silicon solar battery manufactured by plasma chemical vapor deposition (P-CVD) on the oxide film.

In co-pending application serial number (CL4932), is disclosed a steel substrate having a coating of glass, and having disposed between the glass and the steel layers a layer of alumina.

There remains a need for process to produce a substrate that has the flexibility of a metal, the surface properties of glass, and can be used in a roll-to-roll process for the manufacture of CIGS cells, without the need for a interlayer coating between the glass coating and the metal substrate.

### SUMMARY

In one aspect the present invention is a multi-layer article comprising:
a) a flexible polymeric substrate; and
b) a glass layer disposed directly on at least a portion of a surface of the flexible polymeric substrate, wherein there are no intervening layers disposed between the glass layer and the surface of the flexible polymeric substrate, wherein the glass layer comprises SiO₂, Al₂O₃, Na₂O, B₂O₃ and, optionally, a metal oxide.

In one aspect the present invention is a process for making a multi- layer article comprising the steps:
1) depositing a glass precursor layer disposed directly onto at least a portion of a surface of a polymeric substrate layer having a thickness of from 10 nm to 1 cm, wherein there are no intervening layers disposed between the glass precursor layer and the surface of the polymeric substrate, and wherein the glass precursor layer comprises: a SiO₂ precursor, an Al₂O₃ precursor, a Na₂O precursor, a B₂O₃ precursor and, optionally, a metal oxide precursor and
b) flash heating for a period of less than 30 seconds the glass precursor layer having a thickness of about 10 nm to about 5 micrometers using a light source, whereby the heating of the glass precursor layer results in localized heating at the polymer surface, and whereby the polymer surface is heated to a temperature of from about 250° C. to about 400° C. for a period of less than about 30 seconds.

### DETAILED DESCRIPTION

In one embodiment, the present invention is a process for depositing and/or forming a glass layer on the surface of a flexible substrate. It can be desirable to impart glass-like properties to the surface of flexible materials in order to overcome at least some disadvantages of using common glass substrates in, for example, photovoltaic cells.

A flexible substrate of the present invention can be a flexible polymeric substrate. Polymeric substrates suitable for use in the present invention can include polyimide polymers and polyethyleneterephthalate (PET) polymers, for example. All polymers are not suitable for use herein. Polymers such as PET can degrade at the high temperatures used in the process of the present invention. However, in one embodiment, the present invention is a process to make such heat-degradable polymers suitable for use in the practice of the present invention, whereby the high temperature is localized only at the surface of the polymer and whereby such localization of heating can substantially reduce the negative effect of high temperature processing on the degradable polymer by avoiding substantial thermal degradation in other regions of the polymer.

In one embodiment, the present invention is an article comprising a glass-coated polymer composite layer. Glass-coated polymer composite layers can be useful in electronic devices or as a component of a photovoltaic cell, for example. For example, a glass-coated PET composite layer can be useful as a barrier layer in a photovoltaic cell. A glass-coated polyimide composite layer can be useful as a substrate layer in a photovoltaic cell for deposition of thin-film photovoltaic cells. Glass coated substrates of the present invention can also be useful in printed wire boards, transistors, and as moisture barriers, for example.

Due to the process temperatures required for firing the glass precursor coating and forming a glass layer on the flexible substrate, a suitable substrate must be able to withstand processing temperatures of greater than 250° C. up to about 800° C.

This process is useful for passivating a surface of a surface of a flexible substrate. The passivation may protect the surface from chemical attack. The glass layer may serve as a thermal and/or electrical insulating layer, or also as an ion barrier, preventing detrimental doping of CIGS from contaminants upon thermal processing of solar cells at elevated temperatures (ion migration prevention at 600° C. has been characterized by ESCA).

By passivation, in the present invention, it is generally meant that the flexible substrate layer is prevented from undesirable interaction with the CIGS layer in a photovoltaic cell. For example, a passivating layer of the present invention acts to: (1) prevent ion contamination of the CIGS layer by stainless steel or other flexible substrate; and (2) smooth irregularities in the surface of the flexible substrate.

This process can be conducted batch-wise or as a continuous process, e.g., in a roll-to-roll process.

Polymer Substrates

In one embodiment, the present invention is a process for depositing a glass layer or a glass precursor layer on the surface of a flexible polymer substrate. A polymer substrate suitable for the practice of the present invention is a thermoplastic or thermoset polymer that is capable of being processed at temperatures above 250° C. without substantial degradation to the polymer chain, or significant deterioration of the desired and/or required properties of the polymer for the intended use of the glass/polymer multilayered article. For example: polyester polymers such as polyethyleneterephthallate (PET) polymers can be suitable; and polyimide polymers can be useful in the practice of the present invention. It can be necessary to heat only the surface of certain polymers, where the will come into contact with the glass layer or glass precursor layer, in order to avoid degradation of the polymer in other regions of the polymeric substrate. Optionally, a filled polymer can be suitable for use in the practice of the present invention. Fillers useful herein are any that are known and conventional in the art, and that can withstand the process conditions, particularly the process temperatures employed herein. For example, glass and talc can be suitable fillers in a flexible polymeric substrate. The amount of filler useful herein should not be an amount that would detract from the useful properties of a flexible polymeric substrate of the present invention, and can be known to one of ordinary skill through ordinary experimentation or from conventional knowledge.

Glass Precursor Layer

In one aspect of this invention, the substrate is coated with a glass precursor layer, followed by steps of drying and firing the glass precursor layer to form a glass layer on the flexible substrate. As described below, the thickness of the glass layer can be increased by carrying out multiple cycles of coating-and-drying before firing, or by carrying out several cycles of coating-drying-and-firing.

The glass layer is formed by coating the surface of the flexible substrate, in whole or in part, with a glass precursor composition. The precursor composition can comprise: (1) a form of silicon that is soluble in at least one solvent; (2) an aluminum compound; (3) a boron-containing compound; (4) a sodium salt and, optionally (5) a potassium salt.

A soluble form of silicon can be, for example, silicon tetraacetate, silicon tetrapropionate, bis(acetylacetonato) bis(acetato) silicon, bis(2-methoxyethoxy) bis (acetato) silicon, bis(acetylacetonato) bis(ethoxy) silicon, tetramethylorthosilicate, tetraethylorthosilicate, tetraisopropylorthosilicate, or mixtures thereof).

An aluminum compound can be, for example: tris(acetylacetonato) aluminum, aluminum methoxide, aluminum ethoxide, aluminum isopropoxide, aluminum n-propoxide, or mixtures thereof) is added as well as a trialkylborate (for example, trimethylborate, triethylborate, tripropylborate, trimethoxyboroxine, or mixtures thereof.

A precursor for sodium oxide can be, for example, sodium acetate, sodium propionate, sodium silicate, sodium alkoxides, sodium borate, sodium tetraphenyl borate, or mixtures thereof.

The optional potassium salt can be, for example, potassium acetate, potassium propionate, potassium methoxide, potassium ethoxide, potassium isopropoxide, or mixtures thereof.

To form the glass precursor composition, the soluble silicon can be dissolved in a solvent such as, for example: (1) a C1-C10 alcohol (for example methanol, ethanol, 1-propanol, 2-propanol, 1-butanol, 2-butanol, isomers of 1-butanol, 1-pentanol, 2-pentanol, 3-pentanol, isomers of 1-pentanol, 1-hexanol, 2-hexanol, 3-hexanol, isomers of 1-hexanol, 1-heptanol, isomers of 1-heptanol, or mixtures thereof); (2) an acid (for example, acetic acid, propionic acid, hydrochloric acid, nitric acid, sulfuric acid, or mixtures thereof) and (3) water to obtain a solution of dissolved silicon solution. Water can be included in an amount of from 0 to 4 mole equivalents, with respect to silicon. Minimal amounts of the solvent can be used, with the caveat that the amount should be sufficient and effective to form a solution of the components.

The sodium salt can be dissolved in the same C1-C10 alcohol used to prepare the initial silicon solution, and added to the silicon solution. In some embodiments, the glass precursor formulation is filtered prior to coating the stainless steel substrate. In some embodiments, the composition of the glass precursors in the formulation is in an element ratio of about 100 (Si) to 45 (B) to 26 (Na) to 3 (Al).

In one embodiment, the precursor composition can be prepared by dissolving a silicon oxide precursor (for example, tetraethylorthosilicate) in a minimum amount of 1-butanol, or a 1:1 mixture of 1-butanol and acetic acid, and stirring. To this solution, two mole equivalents of water are added and the solution is refluxed for one hour. An aluminum oxide precursor (for example, tris(acetylacetonato)aluminum), a boron oxide precursor (for example, triethyl borate) and a sodium oxide precursor (for example, sodium tetraphenylborate) in 1-butanol, are added. Once the precursors are dissolved, more solvent is added to obtain the desired concentration.

The glass layer can optionally include an oxide of lithium, magnesium, potassium, calcium, barium, lead, germanium, tin, antimony, bismuth or any lanthanide. Suitable precursors for Li₂O, MgO, BaO, K₂O, CaO, PbO, GeO₄, SnO₂, Sb₂O₃, Bi₂O₃ or any oxide of a lanthanide metal can include the respective acetates, for example: potassium acetate, calcium acetate, lead acetate, germanium acetate, tin acetate, antimony acetate, and bismuth acetate. Other oxide precursors can be used, as may be known to one of ordinary skill in the art.

Silicon alkoxides (for example, a silicon tetraalkylorthosilicate) and aluminum alkoxides (for example, aluminum isopropoxide) can also be used in the preparation of the glass precursor compositions.

Optionally, borosilicate glass nanoparticles can be added to the formulation.

Depositing a coating of the glass precursor composition onto the flexible substrate can be carried out by any known and/or conventional means, including bar-coating, spray-coating, dip-coating, microgravure coating, or slot-die coating. One of ordinary skill in the art would appreciate the benefits and/or disadvantages of any of these conventional coating means, and could choose an appropriate coating method based on the particulars of the process parameters under consideration. In on embodiment, a glass precursor layer can be disposed directly onto at least a portion of a surface of a polymeric substrate layer having a thickness of from 10 nm to 1 cm, wherein there are no intervening layers disposed between the glass precursor layer and the surface of the polymeric substrate. The glass precursor layer can be heated for a very short duration, for example less than 30 seconds, to effectively heat the polymer surface that is in direct contact with the glass layer, this process is herein defined as flash heating. In a flash heating process as practiced herein, the polymer surface is heated to a temperature of from about 250° C. to about 400° C. for a period of less than about 30 seconds, alternatively for a period of less than 1 second, alternatively for a period of less than 5 milliseconds (5000 microseconds), or alternatively for about 1 millisecond (1000 microseconds). Multiple exposures of the glass substrate to flash heating are contemplated in the process of the present invention.

The duration and number of exposures of the glass layer to flash heating can be dependent on a number of process conditions, including the power generated by the heat source and the effectiveness of bonding the glass to the polymeric substrate at a given set of conditions. Destruction of the polymer is to be avoided under any set of conditions.

After coating the glass precursor composition onto the flexible substrate, the precursor is typically dried in air at 100 to 150° C. to remove solvent. In some embodiments, the dried glass precursor layer is then fired in air or an oxygen-containing atmosphere at 250 to 800° C. to convert the glass precursor layer to a fired glass layer. By “firing” it is meant that the glass precursor layer is heated above the decomposition temperature of the precursors in an oxidizing atmosphere to:
1) remove any organic ligands used to solubilize the glass precursors in the coatable solution and;
2) oxidize silicon, aluminum, boron and sodium components of the solution to their respective oxide form and;
3) form a thin, dense glass film on the substrate.

It can be desirable to increase the thickness of the fired glass layer by carrying out additional cycles of (1) depositing the glass precursor on surface of the substrate (coating) and (2) drying prior to firing.

The cycle of (1) coating followed by (2) drying can be repeated numerous times, depending on the thickness of the glass layer that is desirable, and the number of repetitions that are needed to obtain the desired thickness. Typically the desired thickness can be obtained with 2-5 repetitions of the coating/drying cycle.

The thickness of the fired glass layer can be from about 1 nm to several micrometers in thickness. In certain embodiments, the thickness of the glass fired layer can be in the range of from about 10 nm to several microns in thickness. In some uses -- for example when used in a photovoltaic cell -- it can be desirable to increase the flexibility of the fired glass layer by reducing its thickness to within the range of from about 10 nm to about several microns, or from about 25 nm to about 10 micrometers, or from about 50 nm to about 5 micrometers, or less than about 3 micrometers. However, the desired thickness for flexibility can depend on the application, the composition, or other factors. For example, in some applications pinholes in the glass layer can be desirable and it can therefore be desirable to reduce the thickness of the glass layer to allow pinholes. In other applications the thickness can be increased to provide optimum insulation, therefore, minimum pinholes in the glass layer. In any event, the purpose of the present invention is to provide flexibility to a glass layer whereby normal handling does not produce cracks in the glass. Cracks, even if observable only with a microscope, are undesirable. To avoid cracking in the glass layer, an upper thickness limit for the glass layer may be reached at about 5 micrometers, or at about 4 micrometers, or at about 3 micrometers.

Optionally, the steps of (1) coating, (2) drying, and (3) firing can be repeated 2 or more times. This can also increase the total thickness of the fired glass layer. Multiple intermediate firing steps facilitate removal of any carbon that might be present in the glass precursor components, and therefore multiple firing steps can be preferred.

Also optionally, the drying step can be skipped and the glass precursor layer can be pre-fired at lower temperature than the firing step, and then subsequently fired. It can be advantageous to pre-fire the glass precursor layer to, for example: drive off solvent at a faster rate; facilitate gellation of the glass precursor layer; and/or to facilitate other interactions among the components of the glass precursor layer. Any combination of drying, pre-firing and firing steps can be repeated multiple times to get the thickness or other properties desirable in the final glass layer.

In some embodiments, water is added to the precursor mixture prior to the coating step. This increases the viscosity of the glass precursor composition and facilitates the formation of glass layers of 50 nm to 2 microns thickness in one coating and drying cycle.

Both the firing step(s) and drying step(s) are typically conducted in air to ensure complete oxidation of the glass precursors. The presence of elemental carbon, carbonate intermediates or reduced metal oxides in the glass layer may lower the breakdown voltage of the insulating layer.

After firing, the glass layer typically comprises: greater than 70 wt % silica; less than 10 wt % alumina; 5-15 wt % of a boron oxide; and less than 10 wt % of oxides of sodium and/or potassium. In one embodiment, the fired glass layer comprises: about 81 wt % SiO₂, about 13 wt % B₂O₃, from about 1% up to about 4 wt % Na₂O, and about 2 wt % Al₂O₃.

In some embodiments, the glass precursor compositions are selected to provide coefficients of linear thermal expansion (CTE) of the glass layers to be close to those of the Mo and CIGS (or CZTS-Se) layers to reduce stress on the Mo and CIGS (or CZTS-Se) layers and to reduce film curling. In some embodiments, the CTE of the borosilicate glass is about 3.25×10⁻⁶/° C. to provide a good match to the CTE of the Mo layer (about 4.8×10⁻⁶/° C.) and the CIGS layer (about 9×10⁻⁶/° C.).

One aspect of this invention is a multi-layer article comprising:
a) a flexible polymer substrate;
b) a glass layer disposed directly on at least a portion of the flexible polymer substrate, wherein the glass layer comprises SiO₂, Al₂O₃, Na₂O, B₂O₃, and optionally an oxide selected from the group consisting of Li₂O, BeO, BaO, MgO, K₂O, CaO, MnO, NiO, SrO, FeO, Fe₂O₃, CuO, Cu₂O, CoO, ZnO, PbO, GeO₄, SnO₂, Sb₂O₃, Bi₂O₃, and any oxide of a lanthanide metal.

The flexible polymer substrate and glass layer are as described above.

This multilayer article can be used as the substrate for the manufacture of electronic devices, such as for example, organic light emitting diode display applications, white light organic light emitting diode applications, photovoltaic applications. Such multilayer articles can also be used in medical devices such as heart valves.

In some embodiments, the multilayer article further comprises:
d) a conductive layer disposed on at least a portion of the glass layer.

In some embodiments, the multilayer article further comprises:
e) a photoactive layer disposed on the conductive layer;
f) a CdS layer disposed on the photoactive layer; and
g) a transparent conductive oxide disposed on the CdS layer.

Such multilayer articles can be used in photovoltaic cells, for example.

Suitable conductive layers comprise materials selected from the group consisting of metals, oxide-doped metals, metal oxides, organic conductors, and combinations thereof. A conductive metal layer can be deposited onto the glass layer through a vapor deposition process or electroless plating. Suitable metals include Mo, Ni, Cu, Ag, Au, Rh, Pd and Pt. The conductive metal layer is typically 200 nm-1 micron thick. In one embodiment, the conductive material is molybdenum oxide-doped molybdenum.

In some embodiments, the multilayer article comprises organic functional layers, e.g., organic conductors such as polyaniline and polythiophene. In such embodiments, the multilayer article is generally not heated above 450° C., or 400° C., or 350° C., or 300° C., or 250° C., or 200° C., or 150° C., or 100° C. after the organic functional layer has been deposited.

Suitable photoactive layers include CIS (cadmium-indium-selenide), CIGS, and CZTS-Se.

The CIGS and CIS layers can be formed by evaporating or sputtering copper, indium and optionally gallium sequentially or simultaneously, then reacting the resulting film with selenium vapor. Alternatively, a suspension of metal oxide particles in an ink can be deposited on the conductive layer using a wide variety of printing methods, including screen printing and ink jet printing. This produces a porous film, which is then densified and reduced in a thermal process to form the CIGS or CIS layer. The processes described hereinabove are known and conventional in the art. In fact, any known or conventional process can be used to form the CIGS or CIS layers.

CZTS-Se thin films can be made by several methods, including thermal evaporation, sputtering, hybrid sputtering, pulsed laser deposition, electron beam evaporation, photochemical deposition, and electrochemical deposition. CZTS thin-films can also be made by the spray pyrolysis of a solution containing metal salts, typically CuCl, ZnCl₂, and SnCl₄, using thiourea as the sulfur source.

The CdS layer can be deposited by chemical bath deposition, for example. Other means that are known and/or conventional can be used.

A suitable transparent conductive oxide layer, such as doped zinc oxide or indium tin oxide, can be deposited onto the CdS layer by sputtering or pulsed layer deposition, for example. Other methods that are known and/or are conventional to one of ordinary skill in the art can be used.

### EXAMPLES

### Example 1

### Sodium Aluminoborosilicate Glass Composition having 10% Weight NA₂O Coated on Kapton®

A 0.5M precursor formulation with respect to [Si] was prepared in the following manner:

2.4109 g (11.57 mmol) of tetraethylorthosilicate (Sigma Aldrich, >99.0% purity) was dissolved in 10 ml of 1-butanol. To this solution, was added 1.5 mole equivalents of glacial acetic acid (1.0400 g; 17.35 mmol, EMD, >99.7% purity) and 1 drop (0.02 g) of nitric acid. The solution was then refluxed at 118° C. for 2 h. Upon reflux completion and in the following order of addition, 0.2873 g (2.99 mmol) of sodium propionate (Sigma Aldrich, >99% purity), 0.1179 g (0.36 mmol) of tris(acetylacetonato) aluminium (Sigma Aldrich, >99% purity) and 0.5054 g (3.46 mmol) of triethylborate (Sigma Aldrich, 99% purity) were added to the solution at room temperature. The solution was then stirred until clear and 1-butanol was added until the total volume of 25.00 ml was achieved.

A 50.8 micrometer thick Kapton® (DuPont) film was diced to size and cleaned by rinsing the surface with methanol and/or argon plasma cleaned (A.G. Services PE-PECVD System 1000) under the following conditions for a time of 30 s:
power=24.3 W
pressure=100.0 mTorr
throttle pressure=200.0 mTorr
argon gas flow=10.0 sccm

The glass precursor formulation was filtered using a 0.45 micron PTFE filter.

The cleaned polyimide substrate was rod-coated with a #40 bar on a Cheminstrument® motorized drawdown coater with 0.1 ml of filtered glass precursor formulation at room temperature in a clean room environment (class 100). The coated sample was then dried at room temperature for 30 s, then at 150° C. for 2 minutes.

The drawdown coating and drying, cycle was repeated under the same conditions until the desired thickness was obtained.

The final layer was then fired to 400° C. for 2 minutes at a ramp rate of 10° C./s.

The glass coating integrity was characterized by ESCA to determine glass composition on the top coated surface.

### Example 2

### Sodium Aluminoborosilicate Glass Composition having 10% Weight NA₂O Coated on 50.8 um 30 wt % TIO₂ Filled Polyimide Film

A 0.5M precursor formulation with respect to [Si] was prepared in the following manner:

2.4109 g (11.57 mmol) of tetraethylorthosilicate (Sigma Aldrich, >99.0% purity) was dissolved in 10 ml of 1-butanol. To this solution, was added 1.5 mole equivalents of glacial acetic acid (1.0400 g; 17.35 mmol, EMD, >99.7% purity) and 1 drop (0.02 g) of nitric acid. The solution was then refluxed at 118° C. for 2 h. Upon reflux completion and in the following order of addition, 0.2873 g (2.99 mmol) of sodium propionate (Sigma Aldrich, >99% purity), 0.1179 g (0.36 mmol) of tris(acetylacetonato) aluminium (Sigma Aldrich, >99% purity) and 0.5054 g (3.46 mmol) of triethylborate (Sigma Aldrich, 99% purity) were added to the solution at room temperature. The solution was then stirred until clear and 1-butanol was added until the total volume of 25.00 ml was achieved.

A 50.8 micrometer 30 wt % TiO₂ filled polyimide film (DuPont) was diced to size and cleaned by rinsing the surface with methanol and/or argon plasma cleaned (A.G. Services PE-PECVD System 1000) under the following conditions for a time of 30 s:
power=24.3 W
pressure=100.0 mTorr
throttle pressure=200.0 mTorr
argon gas flow=10.0 sccm

The glass precursor formulation was filtered using a 0.45 micron PTFE filter.

The cleaned polyimide substrate was rod-coated with a #40 bar on a Cheminstrument® motorized drawdown coater with 0.1 ml of filtered glass precursor formulation at room temperature in a clean room environment (class 100). The coated sample was then dried at room temperature for 30 s, then at 150° C. for 2 minutes.

The drawdown coating and drying, cycle was repeated under the same conditions until the desired thickness was obtained.

The final layer was then fired to 400° C. for 2 minutes at a ramp rate of 10° C./s.

### Example 3

### Sodium Aluminoborosilicate Glass Composition having 10% Weight NA₂O Coated on 50.8 um 30 wt % Talc Filled Polyimide Film

A 0.5 M precursor formulation with respect to [Si] was prepared in the following manner:

2.4109 g (11.57 mmol) of tetraethylorthosilicate (Sigma Aldrich, >99.0% purity) was dissolved in 10 ml of 1-butanol. To this solution, was added 1.5 mole equivalents of glacial acetic acid (1.0400 g; 17.35 mmol, EMD, >99.7% purity) and 1 drop (0.02 g) of nitric acid. The solution was then refluxed at 118° C. for 2 h. Upon reflux completion and in the following order of addition, 0.2873 g (2.99 mmol) of sodium propionate (Sigma Aldrich, >99% purity), 0.1179 g (0.36 mmol) of tris(acetylacetonato) aluminium (Sigma Aldrich, >99% purity) and 0.5054 g (3.46 mmol) of triethylborate (Sigma Aldrich, 99% purity) were added to the solution at room temperature. The solution was then stirred until clear and 1-butanol was added until the total volume of 25.00 ml was achieved.

A 50.8 micrometer 30 wt % talc filled polyimide film (DuPont) was diced to size and cleaned by rinsing the surface with methanol and/or argon plasma cleaned (A.G. Services PE-PECVD System 1000) under the following conditions for a time of 30 s:
power=24.3 W
pressure=100.0 mTorr
throttle pressure=200.0 mTorr
argon gas flow=10.0 sccm

The glass precursor formulation was filtered using a 0.45 micron PTFE filter.

The cleaned polyimide substrate was rod-coated with a #40 bar on a Cheminstrument® motorized drawdown coater with 0.1 ml of filtered glass precursor formulation at room temperature in a clean room environment (class 100). The coated sample was then dried at room temperature for 30 s, then at 150° C. for 2 minutes.

The drawdown coating and drying, cycle was repeated under the same conditions until the desired thickness was obtained.

The final layer was then fired to 400° C. for 2 minutes at a ramp rate of 10° C./s.

### Example 4

### 10% Weight NA₂O Sodium Aluminoborosilicate Glass Composition Coated on Kapton®

A 0.5M precursor formulation with respect to [Si] was prepared in the following manner:

2.4109 g (11.57 mmol) of tetraethylorthosilicate (Sigma Aldrich, >99.0% purity) was dissolved in 10 ml of 1-butanol. To this solution, was added 1.5 mole equivalents of glacial acetic acid (1.0400 g; 17.35 mmol, EMD, >99.7% purity) and 1 drop (0.02 g) of nitric acid. The solution was then refluxed at 118° C. for 2 h. Upon reflux completion and in the following order of addition, 0.2873 g (2.99 mmol) of sodium propionate (Sigma Aldrich, >99% purity), 0.1179 g (0.36 mmol) of tris(acetylacetonato) aluminium (Sigma Aldrich, >99% purity) and 0.5054 g (3.46 mmol) of triethylborate (Sigma Aldrich, 99% purity) were added to the solution at room temperature. The solution was then stirred until clear and 1-butanol was added until the total volume of 25.00 ml was achieved.

A 50.8 micrometer thick Kapton® (DuPont) film was diced to size and cleaned by rinsing the surface with methanol and/or argon plasma cleaned (A.G. Services PE-PECVD System 1000) under the following conditions for a time of 30 s:
power=24.3 W
pressure=100.0 mTorr
throttle pressure=200.0 mTorr
argon gas flow=10.0 sccm

The glass precursor formulation was filtered using a 0.45 micron PTFE filter.

The cleaned polyimide substrate was rod-coated with a #40 bar on a Cheminstrument® motorized drawdown coater with 0.1 ml of filtered glass precursor formulation at room temperature in a clean room environment (class 100). The coated sample was then dried at room temperature for 30 s, then at 150° C. for 2 minutes.

Samples were then exposed to 1000 microsecond pulse lengths at four different relative doses ranging between 51% and 100% of a broad wavelength light spectrum between 200 nm and 1000 nm using a PulseForge 3300 instrument developed by NovaCentrix® to cure the glass films on the polyimide substrate without compromising the integral properties of the substrate that was coated. The coated film was exposed to a peak power >100kW/cm² for a 1000 microsecond pulse which was sufficient to form the glass on the polyimide substrate. The final coating was analyzed by ESCA to determine the chemical composition of the coating which confirmed the sodium aluminoborosilicate glass composition on the exposed top surface.

What is claimed is:

1. A multi-layer article comprising:
a) a flexible polymeric substrate layer; and
b) a glass layer disposed directly on at least a portion of a surface of the flexible polymeric substrate layer, wherein there are no intervening layers disposed between the glass layer and the surface of the flexible polymeric substrate, wherein the glass layer comprises SiO₂, Al₂O₃, Na₂O, B₂O₃ and, optionally, a metal oxide.

2. The article of claim 1 wherein the polymeric substrate is a polyimide polymer or a polyester polymer.

3. The article of claim 1 wherein the polymer substrate comprises filler.

4. The article of claim 3 wherein the polymeric substrate is a polyimide.

5. The article of claim 4 wherein the filler is glass or talc.

6. The article of claim 5 wherein the filler is talc.

7. A process for making a multi-layer article comprising the steps:
1) depositing a glass precursor layer disposed directly onto at least a portion of a surface of a polymeric substrate layer having a thickness of from 10 nm to 1 cm, wherein there are no intervening layers disposed between the glass precursor layer and the surface of the polymeric substrate, and wherein the glass precursor layer comprises: a SiO₂ precursor, an Al₂O₃ precursor, a Na₂O precursor, a B₂O₃ precursor and, optionally, a metal oxide precursor and
b) flash heating for a period of less than 30 seconds the glass precursor layer having a thickness of about 100 nm to about 5 micrometers using a light source, whereby the heating of the glass precursor layer results in localized heating at the polymer surface, and whereby the polymer surface is heated to a temperature of from about 250° C. to about 400° C. for at least one period of less than about 30 seconds.

8. The process of claim 7 wherein the polymeric substrate is a polyimide polymer.

9. The process of claim 8 wherein the polymer surface is heated for at least one period of about 1000 microseconds.

10. An article made by the process of claim 7.
